(19) United States
(12) Patent Application Publication
(10) Pub. No.: US 2019/0090989 A1
(43) Pub. Date: Mar. 28, 2019

(54) BRACKET FOR AN ORTHODONTIC DEVICE

(71) Applicant: YONG-MIN JO, Duesseldorf (DE)

(72) Inventor: YONG-MIN JO, Duesseldorf (DE)

(21) Appl. No.: 16/197,254

(22) Filed: Nov. 20, 2018

Related U.S. Application Data
(63) Continuation of application No. PCT/EP2017/063217, filed on May 31, 2017.

(30) Foreign Application Priority Data
Jun. 2, 2016 (DE) DE102016110161.3

(51) Int. Cl. A61C 7/28

(52) U.S. Cl. CPC A61C 7/28; A61C 7/20

(57) ABSTRACT

A bracket, for an orthodontic device, the bracket including a bracket base including an attachment surface configured to attach the bracket at an associated surface of a tooth; at least one bracket slot configured to receive at least one arch wire of the orthodontic device, wherein the bracket slot is arranged on a side of the bracket base that is oriented away from the attachment surface; and at least one locking device that is configured to lock at least the bracket slot at least partially so that the arch wire is prevented from moving out of the bracket slot, wherein the bracket is integrally formed in one piece, wherein the bracket is configured with a convex camber at a back side that is oriented away from the attachment surface, wherein the convex camber extends over at least 50% of a height of the bracket that is measured parallel to the vertical axis of the bracket.

### RELATED APPLICATIONS

This application is a continuation of International application PCT/EP 2017/063217 filed on May 31, 2017, claiming priority from German patent application DE 10 2016 110 161.3, filed on Jun. 2, 2016, both of which are incorporated in their entirely by this reference.

### FIELD OF THE INVENTION

The instant application relates to a bracket for an orthodontic device, the bracket comprising: a bracket base including an attachment surface for attaching the bracket at an associated surface of a tooth; at least one bracket slot for receiving at least one arch wire of the orthodontic device, wherein the bracket slot is arranged on a side of the bracket base that is oriented away from the attachment surface; and at least one locking device that is configured to lock at least the bracket slot at least partially so that the arch wire is prevented from moving out of the bracket slot, wherein the bracket is integrally formed in one piece.

The instant application also relates to an orthodontic device comprising at least one arch wire; a plurality of brackets configured to receive the arch wire, wherein the brackets are configured to be connected with a respective surface of a tooth in a force transferring manner, wherein the arch wire is receivable by the brackets so that a force transmitting connection is establishable between the arch wire and the teeth that cooperate with the brackets, wherein the bracket includes at least one bracket slot configured to receive the arch wire and the arch wire is fixable in the bracket slot by a locking device so that a movement of the arch wire relative to the bracket slot is blocked at least in a direction perpendicular to a longitudinal axis of the arch wire, wherein the bracket slot cooperates with an insertion opening of the bracket, wherein the arch wire is insertable into the bracket slot through the insertion opening, wherein the brackets are respectively integrally configured in one piece.

Last but not least, the instant application relates to a method for producing brackets.

The orthodontic device is a brace which is configured to actively treat a tooth misalignment of a patient. This is performed in that at least one arch wire of the brace is engaged in the brackets so that a force transmission can be provided between the arch wire and the respective teeth to be treated. In order to treat the tooth misalignment with the orthodontic device, many types of braces are known in the at It is conceivable, for example, to store a force information directly in the arch wire and to transfer the force information to the teeth through the brackets. Alternatively, it is conceivable to configure a bracket slot of a respective bracket in a particular manner so that a deformation is predetermined by inserting a rather stiff arch wire so that a reset force forms in the arch wire. The reset force is then transmitted to the teeth by the brackets and eventually the movement of the teeth in the respective jaw bone is caused. It is irrelevant for the instant application which type of orthodontic device is being used.

The bracket base describes the portion of the bracket that is brought into direct contact with a respective tooth. For this purpose, the bracket base includes a respective attachment surface that forms a contact surface between the bracket base and a respective surface of a tooth. The attachment surface can thus be formed at a dedicated attachment section of the bracket base.

The bracket slot is the portion of a bracket that is configured to receive a respective arch wire. Advantageously, arch wires with edges are used in the art so that a bracket slot for a bracket is also typically configured with corners. For the configuration of the bracket slot it can be advantageous in particular that the bracket slot is adapted to dimensions of the respective arch wire so that a force transmission between the arch wire and the bracket can be provided loss-free, this means without uncontrolled movement of the arch wire in the bracket slot. It is conceivable that an individual bracket includes a plurality of bracket slots for a plurality of arch wires.

A locking device according to the instant application is a device that facilitates fixating the respective arch wire in the bracket slot. Fixing the arch wire does not necessarily include a complete fixing, this means that a movement of the arch wire relative to the bracket or the bracket slot is blocked in all directions. Instead, it can suffice already when the locking device closes the bracket slot only so that a movement of the arch wire from the bracket slot is prevented, however, a relative movement between the arch wire and the bracket in a direction parallel to a longitudinal axis of the arch wire is enabled. It is appreciated that devices are also locking devices according to the instant application which can cause a complete blockage of any relative movement between an arch wire and the respective bracket.

An arch wire according to the instant invention is an elongated arc-shaped element that is used to connect the individual brackets with each other. Depending on the type of orthodontic device, the arch wire can play an active or a passive role. In any case, it is not mandatory that the arch wire is formed by a metal wire though this is typically the case.

An integral configuration in one piece according to the instant application means that the bracket is fabricated from a single block of material. In particular it is conceivable that the bracket is fabricated from a block of material, for example, by cutting it out by a laser, by water jet cutting or milling. The water jet cutting is particularly advantageous when the material block has a certain thickness, wherein the water jet cutting has the advantage that the material piece is not heated. Alternatively, it is conceivable to master form a one-piece component, e.g., casting it or using a 3-D printing method. Also using this fabrication method, the finished bracket is formed by a single part and not assembled from several parts.

In particular the bracket according to the invention does not allow to tell individual components of the bracket from each other when the bracket is finished. Instead, all sections or portions of the bracket are connected with each other so that they transition into each other directly. In particular it is conceivable that the bracket according to the invention is made in its entirety from one piece of material and therefore made from a single material. By the same token, it is also conceivable for a one-piece configuration that several components are produced separately from each other while producing the bracket and are then joined to form a single component. This connection is then provided in a manner so that a transition between the originally separate components is no longer discernable after the joining is completed. In particular it is conceivable in particular that originally separate components are bonded together, e.g., by welding or melting.

### BACKGROUND OF THE INVENTION

Brackets of the generic type described supra are known in the art and disclosed, e.g., in International patent applications WO 96109015 A1 and WO 2011/012486 A1.

The first document discloses a self-ligating bracket that includes a bracket base and a bracket slot. Lobes are arranged at the bracket base on a side that is oriented away from an attachment surface of the bracket wherein the lobes laterally define the bracket slot of the bracket. The lobes have a locking device at an end of the lobes that is oriented away from the bracket base wherein the locking device is configured to retain an arch wire that is inserted into the bracket slot. The locking device is configured in a form of protruding lugs that protrude into an insertion opening of the bracket slot. Thus, it is hardly possible to unintentionally remove an arch wire that is inserted into the bracket slot wherein the removal from the bracket slot is attempted in a direction that is oriented perpendicular to an orientation of the bracket slot. The bracket that is introduced in the document includes a total of two lobe pairs that are arranged on the bracket base offset from each other. Between these lobes the arch wire that is inserted into the bracket slot or into the bracket slots formed by the lobe pairs is freely supported. The described bracket is in particular integrally injection molded in one piece from a synthetic material.

The second International patent application describes a bracket which is also configured self-ligating. It is a particular feature of this bracket that the bracket is integrally made in one piece by Nitinol, wherein in particular side lobes of the bracket are integrally made in one piece together with the bracket base. The bracket slot is locked by hook-shaped locking devices so that the arch wire is fixed in the bracket slot.

Known brackets have the particular disadvantage in the course of a combined orthodontic treatment that initially uses a classic orthodontic device and subsequently a rail therapy that they have to be removed after completion of the treatment with the orthodontic device. This time sequence of steps of the entire treatment method is quite common in practical applications. Thus, in many cases a general direction of the respective tooth misalignments is treated in a first treatment step with a typical brace, and a small remaining tooth misalignment is treated in a second treatment step with a tooth rail. The latter method has the disadvantage of being hardly suited to cause large movements of teeth and thus to completely treat larger tooth misalignments. However, the method has the advantage that the tooth rails that have to be worn during the rail therapy enjoy a particularly high level of acceptance with the patients and are hardly visible.

Simultaneously so-called attachments are placed on the teeth to be treated for the subsequent rail therapy wherein the attachments increase an effectiveness of a respective rail and thus accelerate the treatment success of the rail therapy. The entire treatment is very complex and requires a plurality of steps.

### BRIEF SUMMARY OF THE INVENTION

Thus it is an object of the instant application to provide an option to simplify an orthodontic treatment of a patient.

The object is achieved by improving according to the invention upon a bracket of the generic type recited supra in that the bracket is provided with a convex camber on a back side of the bracket that is oriented away from the attachment surface wherein the convex camber extends over at least 50% of an entire height of the bracket that is measured parallel to a vertical axis of the bracket.

A camber according to instant application is a portion of the bracket in which an outer contour of the bracket is configured cambered wherein the back side of the bracket is configured curved in one dimension, in particular in a direction parallel to the vertical axis of the bracket. According to the invention the camber is configured convex.

The vertical axis of the bracket is an axis which extends on the one hand side perpendicular to a longitudinal axis of the bracket slot, and on the other hand side includes an upper and a lower end location of the attachment surface of the bracket base. The attachment surface thus designates a surface by which the bracket or the bracket base directly contacts a respective facing tooth surface, Thus, the attachment surface is a contact surface between the bracket and the respective surface of the tooth. Thus, it is appreciated that the attachment surface has an upper end and a lower end with respect to an elevation axis of a respective tooth to be treated wherein a contact zone between the respective tooth surface and the attachment surface ends at the upper end and at the lower end. Typically the attachment surface has a slightly convex shape that is adapted to a convex shape of a lingual surface of the respective tooth to be treated. Thus, the attachment surface is often not completely in a plane since the respective corresponding tooth surface is not flat either. Thus, the definition of the vertical axis does not include a parallel alignment of the vertical axis with a plane of the attachment surface but rather a parallel alignment with a plane that includes an upper edge as well as a lower end location of the attachment surface, this means opposite end locations between the bracket base and the respective contacting tooth surfaces. These end locations are determinable independently from a connection of a respective bracket with a tooth at the bracket since the bracket forms a dedicated attachment surface by itself. This is evident in an exemplary manner from the subsequently described embodiments.

The bracket according to the invention has many advantages. Thus, the invention is based on the idea to configure the brackets so that they function directly as an attachment for a first treatment step in which the teeth are treated by the orthodontic device and reusable for the second treatment step, namely the rail therapy. The bracket is suitable as an attachment due to its camber according to the invention which is useable as an engagement point for the tooth rail that is used for rail therapy. The configuration according to the invention of at least one bracket with the described camber facilitates to not separate the bracket from the respective tooth after completion of the first treatment step but to leave it in an oral cavity of the patient and to subsequently use it in the function of an attachment for a subsequent rail therapy.

In a particularly advantageous embodiment of the bracket according to the invention a backside of the bracket is configured completely without a recessed shoulder in the portion of the camber. Configured without recessed shoulder according to the instant application means that the back side of the bracket runs continuously, this means without leaps in the contour of the back side wherein backward leaps that are oriented towards the bracket base are known in the art. In particular a backward leap of this type can be formed by an insertion opening for a bracket slot. In particular the back side has no notches, slots or similar in the portion of the camber. Advantageously the back side of the bracket is provided without an undercut.

The configuration of the camber without undercut has the advantage that the tooth rail as such that has rather thin walls cannot tighten at the bracket so that a switching of the tooth rail with another tooth rail becomes impossible or very difficult. Thus, it is appreciated that a plurality of brackets is used in a predetermined sequence during rail therapy, wherein each tooth rail causes a predetermined movement increment of the teeth to be treated, so that a desired end position of the teeth is eventually provided in total by using all tooth rails. This marks the end of the active orthodontic treatment. If the bracket has a recessed shoulder or even an undercut in the portion of the camber there is a risk that the foil material of a typical tooth rail pulls into this recess so that removing the tooth rail becomes either impossible or very difficult.

Further configuring the camber it extends over at least 60% of a height of the bracket, advantageously over at least 70%, further advantageously over at least 80%. Since the brackets are often very small the rather large configuration of the camber can assure that a contact surface of a respective tooth rail at the bracket functioning as an attachment suffices to transfer the intended forces or to provide sufficient leverage.

The bracket according to the invention can have a particularly advantageous effect when a thickness of the bracket that is measured in a direction perpendicular to the vertical axis of the bracket is at least 1.5 times, advantageously at least 2 times, as thick in the portion of the camber as an average thickness of the bracket outside of the camber. Put differently the bracket extends with its camber into a direction that is oriented away from the tooth surface. Looking at a lingually arranged bracket the camber therefore extends in a direction towards a tongue of the respective patient. A camber of this type is particularly well suited as an engagement point for a tooth rail that is used for rail therapy. Put differently the accordingly configured bracket is particularly well suited to function as an attachment.

In another advantageous embodiment of the bracket according to the invention the bracket is at least partially advantageously completely formed from a highly elastic material, advantageously a shape memory material. A highly elastic material according to the instant application is a material which has a very pronounced elastic range, this means that the material can go through considerable elastic deformations without being permanently, this means plastically deformed. In particular a material of this type is capable to perform an elongation of at least 1%, advantageously at least 2%, further advantageously at of least 3% without going through a plastic deformation.

A material type which typically has the described highly elastic properties is the so called shape memory material. According to the invention the shape memory material is a super elastic material. A material of this type is sometimes designated in the art as a shape memory alloy. Materials of this type are characterized in particular by their pseudo elastic properties. This means they have an extremely pronounced elastic zone in which a component that is formed by the material can be deformed without causing a plastic deformation. It is also typical for a material of this type that the conversion between their “Martensite-condition” to their “Austenite-condition” can be performed back and forth so that plastic deformations can be back converted.

It is also conceivable to use special synthetic materials for the highly elastic material wherein the special synthetic materials have the recited mechanical properties. This can be useful in particular when materials of this type are processable by a 3-D printing method since a bracket according to the invention can be produced in a particularly simple manner by this method. This will be address infra.

A bracket according to the invention can be made for example from a polyetherketone, in particular polyetheretherketone (PEEK), from a thermoplastic Fluor synthetic material, in particular polyvinylidenfluoride (PVFD), polyoxymethylene (POM) or a polymide, in particular polyetherimide (PEI).

Even when the bracket is not entirely made from a highly elastic material, in particular a shape memory material it is at least advantageous when at least the portion formed from the highly elastic material is made from Nitinol, PEEK, PVFD, POM or PEI. Using a highly elastic material is particularly advantageous for the integral configuration of the bracket according to the invention. The reason is that a material of this type has the described particularly pronounced range which prevents forming plastic deformations at least essentially. This is significant in that the connecting device that is configured at the bracket has to be configured overall due to the bracket being integrally provided in one piece to perform a certain movement relative to the remaining bracket. Thus, it is appreciated that the locking device has to be displaceable in order to accommodate an arch wire that is being inserted. Compared to the prior art it is not possible to configure the locking device movable e.g. by a dedicated movement axis relative to the remaining bracket, e.g. by a rotation axis. Instead a certain amount of reversible deformability of the bracket is required in the portion of the locking device due to the one piece configuration. Due to the particularly elastic properties of the highly elastic material, a bracket that is formed from this material is therefore advantageous.

Using nitinol is furthermore advantageous since it has a high level of biocompatibility, This also applies for the synthetic materials recited supra in particular for PEEK. This furthermore has the advantage it can be provided with a color that is similar to a tooth color so that the bracket is hardly visible. This is of interest in particular for orthodontic devices where the brackets are to be arranged on a side of the teeth that is oriented away from the tongue (buccal).

It is in particular advantageous when at least the looking device of the bracket is formed from a highly elastic material. This is based on the idea that the locking device has to move during insertion of the arch wire into the bracket slot so that the insertion opening of the bracket slot expands so that the cross section of the arch wire fits through. As soon as the arch wire is inserted into the bracket slot the locking device has to be reshaped so that it blocks the insertion opening again. When using the highly elastic material, in particular the shape memory material the locking device can move backward due to its elastic properties so to speak automatically due to the stored reset force and can close the insertion opening this way. In particular it is possible to open and close a locking device of this type multiple times without damaging the bracket since the deformation of the locking device works without plastic deformation portions. Thus, the bracket according to the invention is suitable in particular for treatments where a multitude of arch wires is used as the treatment progresses. The arch wires can be inserted by the bracket according to the invention in a particularly simple manner and can be retrieved again.

In a particularly advantageous embodiment of the bracket according to the invention an insertion opening is configured at the bracket so that inserting an arch wire into the bracket slot is facilitated at least in a direction that is parallel to a vertical axis of the bracket. Thus, the insertion opening describes an opening of the bracket through which an arch wire is insertable into the bracket slot. A bracket may have several insertion openings e.g. when several arch wires are to be used.

The described orientation of the insertion opening has the effect that the arch wire is inserted into the bracket slot in a direction that is parallel to the vertical axis of the bracket. Put differently, when inserting the respective arch wire into the bracket this is not performed like according to the prior art by inserting it into the bracket slot in a direction that is orthogonal to the tooth surface, but in a direction that is parallel to the tooth surface. Due to this insertion direction of the arch wire it comes as a consequence that the bracket has its insertion opening in particular on top, e.g. at a top side but not at its back side. This configuration is helpful in order to prevent recessed shoulders in the portion of the back side and thus in particular in the camber according to the invention.

As an additional advantage and accidental movement of the arch wire from the bracket slot occurs much less frequently since an advantageous movement direction of the arch wire relative to a respective tooth is oriented in a direction that is orthogonal to the tooth surface. Due to the described orientation of the insertion opening the bracket slot is completely blocked at this location by a corresponding wall, so that an accidental exiting of the respective arch wire through the insertion opening is not to be expected.

If can be particular advantageous when the bracket slot is defined at a side surface by the locking device and defined at the opposite side surface by the bracket base, It is appreciated that the bracket slot has to have a plurality of walls as a matter of principle wherein the walls define a space for receiving a respective arch wire. At least one of the walls should be formed by the locking device so that the wall can be released by a movement of the locking device in order to either insert an arch wire into the respective bracket slot or to remove the arch wire again. Thus, it has proven advantageous for a particularly simple configuration of the bracket according to the invention when at least one wall of the bracket slot is directly formed by the bracket base, this means the wall is not used for connecting the bracket overall with a respective tooth but already acts as part of the bracket slot. The locking device can envelop in this embodiment so to speak only a portion about the bracket base, wherein the bracket base and the locking device jointly form a free cross section which eventually forms the bracket slot.

It is a particular advantage of this embodiment that a thickness of the bracket measured perpendicular to a respective tooth surface can be rather small in spite of the camber. In particular it is not necessary to arrange a separate bracket slot on an entire bracket base. The smaller dimensions of the bracket according to the invention contribute in particular to increased wear comfort and to a smaller risk that the respective bracket separates from the tooth surface accidentally through chewing forces or similar. The suitability of brackets thus configured as an attachment is maintained since the bracket protrudes significantly beyond the surface of the respective tooth with the camber of the bracket. A corresponding embodiment of the bracket is evident from the subsequent embodiments.

In a particularly advantageous embodiment of the bracket according to the invention the bracket base transitions directly into the locking device. Thus, advantageously a transition from the bracket base to the locking device is configured by a bar whose cross section at a thickest location is 50% at the most, advantageously 40% at the most, further advantageously at least 30% at the most of a height that is measured parallel to the vertical axis of the bracket. Put differently the bar has a rather small cross section compared to the remaining bracket. This is particularly advantageous with respect to an elastic deformability of the locking device since the bracket has reduced stiffness in a portion of the bar. This has the consequence that the bracket is movable or deformable relative to the bracket base so that the insertion opening for the arch wire or the bracket slot can be expanded and eventually released .

In an advantageous embodiment of the bracket according to the invention the bracket base includes at least one fill-in portion where the attachment surface has a backward recessed shoulder relative to the remaining attachment surface. This way, a direct contact between the section of the attachment surface and a surface of a respective contacting tooth is prevented in the at least one fill-in portion. This means that even when the bracket is applied to a respective tooth the attachment surface within the filling portion does not form any direct contact with the respective tooth surface. For example, it is conceivable that the bracket includes at least one recess at an edge of the bracket which forms the fill-in portion, A fill-in portion of this type is suited particularly well to receive a connecting means that is configured to establish a force transmitting connection of the bracket with the respective tooth, In particular, it is conceivable that a connecting means of this type is formed by a synthetic material that is applied to the tooth surface in a liquid condition and cures thereafter so that a force flow is established between the respective tooth and the bracket, The fill-in portion thus has the effect that the respective connecting means can enter this portion and can provide a better interconnection between the bracket and the tooth, This way it is particularly advantageous when the fill-in portion or the recess forming the fill-in portion is configured undercut, for example, dove-tailed.

Further configuring the bracket according to the invention, a cross-section of the bracket is constant over an entire width of the bracket that is measured parallel to a longitudinal axis of the bracket slot so that all cross-sections that extend perpendicular to the longitudinal axis of the bracket slot are identical. A bracket of this type can be produced in a particularly simple manner compared to the prior art and does not require any complex, 3-D configuration. Furthermore, fabricating a “two dimensional” bracket with a cross-section profile that is always identical is particularly simple,

Independently from the other configuration of the bracket according to the invention, it can be particularly advantageous when a width of the bracket that is measured parallel to a longitudinal axis of the bracket slot is at least 1.5 mm in the portion of the bracket slot, advantageously at least 2 mm, further advantageously at least 2.5 mm. Thus it is advantageous as a matter of principle when a support length of the bracket slot along which an arch wire is continuously supported or supportable in the bracket slot is at least 1.5 mm, advantageously at least 2 mm, further advantageously at least 2.5 mm. Coupling an arch wire over a predetermined support length of the bracket slot facilitates applying a force pair to the bracket through the arch wire. Put differently, it is possible to transfer a bending torque between the arch wire and the respective bracket. Thus, it is only possible by the one-piece configuration of the bracket to arrange a single bracket at the respective tooth surface and to connect it therewith.

A particularly effective treatment method for tooth misalignments works very well in particular with the brackets according to the invention and can be performed as follows.

A method for treating a tooth misalignment, the method comprising the steps:

i) Treating the tooth misalignment with an orthodontic device in a brace treatment step wherein the orthodontic device includes at least one arch wire and a plurality of brackets that cooperate with the teeth, wherein forces are transferred from the arch wire by the brackets to the teeth;

ii) After completing the brace treatment step treating the tooth misalignment with a plurality of sequentially inserted tooth rails in a rail treatment step, wherein a tooth rail that is adapted to a particular tooth position at a moment of insertion of the tooth rail is brought into engagement with the teeth to be treated so that a force transmission is enabled between at least a portion of a surface of the tooth rail that is oriented towards the teeth and the teeth.

According to the invention the treatment method is supplemented with the following treatment step:

iii) Leaving at least a portion of the bracket that is used for the brace treatment step engaged with the respective teeth after the brace treatment step is completed and using the portion of the brackets during the rail treatment step as a transmission element or attachment for the at least one tooth rail,

The method is in particular performed as follows. Initially a tooth misalignment is treated with a typical brace, wherein at least one bracket, advantageously a plurality of brackets, is formed by a bracket according to the invention. In order to perform the treatment step at least one arch wire is inserted into the existing brackets. Typically, a plurality of different arch wires is used in sequence, wherein each arch wire causes a particular movement increment of the teeth to be treated. The individual arch wires are sequentially inserted into the existing brackets and retrieved again and replaced with the next arch wire, The brackets ideally remain permanently arranged at the respective teeth. A replacement of the brackets is not performed as a matter of routine. It is an advantage of a bracket that is formed by a highly elastic material, in particular a shape-memory material, that the material of the bracket, in particular of the locking device, is not subjected to material fatigue, and therefore the insertion opening for the respective arch wire can be expanded and closed again at will.

For completion of the brace treatment the last arch wire is removed from the brackets while at least a portion of the brackets remains at the respective teeth. In the subsequent rail therapy treatment step at least one tooth rail, typically a plurality of tooth rails, is used in order to facilitate another movement of the teeth. Thus, a respective tooth rail is placed over the teeth, wherein an inner surface of the tooth rail cooperates with the respective brackets so that the brackets function as so-called attachments. Thus, the brackets according to the invention perform a double function during the treatment, namely initially they act as an anchoring device for one or plural arch wires and on the other hand side (thereafter) they act as a transmission element for a rail therapy.

Improving upon the orthodontic device recited supra, the object of the invention is achieved in that at least one of the brackets is configured with a convex camber at a backside that is oriented away from the attachment surface, wherein the convex camber extends without a recessed shoulder over at least 50% of an entire height of the bracket that measured parallel to a vertical axis of the bracket. The advantages can be derived from the description provided supra.

The bracket according to the invention can be produced in a particularly simple manner by the subsequently described method according to the invention:

a) Virtually designing a bracket using a CAD method;

b) Producing the virtually designed bracket by a CAM-method wherein the bracket is cut from a piece of material so that the bracket is provided integrally in one piece after completion of the fabrication and has its final usable shape.

As an alternative to the method step according to b) the subsequent method step can be performed:

c) Master forming the virtually designed bracket in a 3-D printing method so that the bracket is integrally provided in one piece after completion of the 3-D printing method and so that the bracket immediately has its final usable shape.

Advantageously and independently from the bracket being cut from a piece of material according to method step b) or printed according to method step c), the method according to the invention includes the additional method steps:

d) Detecting the teeth to be treated by a scanning device and subsequently generating a digital model of the teeth using the scanned data;

e) Designing at least a virtual bracket in the digital model wherein the virtual bracket is adapted to a respective tooth of the digital model so that an attachment surface (3) of the virtual bracket (1) is at least essentially shaped according to a corresponding surface of the respective tooth, so that the attachment surface (3) is applicable at least essentially with its entire surface to the surface of the respective tooth;

f) Cutting a corresponding real bracket (1) from a piece of material or master forming it by a 3-D printing method based on the virtual bracket (1) so that the bracket is integrally provided in one piece after the cutting or master forming and is immediately provided in its final usable shape.

The abbreviation “CAD” stands in this context for “Computer Aided Design” and generally describes a virtual generation of a design using a suitable software of a data processing arrangement. “CAM” stands for “Computer Aided Manufacturing” and specifies an automated fabrication of a workpiece wherein a processing tool is typically moved computer controlled relative to the respective workpiece. This requires no operators for the manufacturing process, and on the other hand side, precision is much higher than during manual fabrication. Additionally excellent reproducibility is provided.

“3-D printing” according to the instant application is a layered buildup of three-dimensional workpieces. A method of this type is typically performed computer-controlled on a basis of digitally generated models. As a matter of principle, it is conceivable that different materials are processed by the 3-D printing method, in particular synthetic materials, synthetic resins, ceramics and metals. The most important techniques of 3-D printing are selective laser melting, selected laser sintering, stereo lithography and synthetic material melting (fused filament fabrication) wherein in particular the three latter methods are also used for synthetic materials and even mostly for synthetic materials,

After completing the method, the respective bracket is directly provided in its final shape, It may still be necessary to release the bracket from a bracket carrier. The shape of the bracket itself, however, is not changed anymore. By the same token, it is conceivable that the bracket should be finished, e.g., in order to remove residues of a 3-D printing method. Thus the final shape of the bracket is not changed anymore,

The method according to the invention has many advantages. In particular, the respective bracket is finished immediately and does not require substantial additional finishing or assembly. This differs considerably from the prior art where the brackets are assembled from several components in any case. The one-piece configuration helps to save fabrication time and furthermore to avoid errors during assembly.

Thus, it can be particularly advantageous to form at least one interlocking element directly at the bracket integrally in one piece at the bracket. This way separate ligature can be omitted which is quite prevalent in the prior art wherein the separate ligature has to be provided at the bracket in order to fix the respective arch wire.

The advantageous embodiment of the method facilitates furthermore to adapt an attachment surface of a respective bracket directly to a respective corresponding tooth surface. This has the particular advantage that the bracket actually only has to have a width that is measured perpendicular to the tooth surface wherein the width is required to provide a reliable anchoring of an arch wire. Differently from the prior art, there is no need for an additional adaptation or compensation layer to adapt a standardized bracket base to an individual tooth surface. A compensation layer of this type has the consequence in the prior art that the respective bracket becomes very wide overall and therefore tends to tear off due to chewing forces. Furthermore, a sensation in the oral cavity from a wide bracket is rather uncomfortable for the patient, Forming the attachment surface of the bracket “essentially” at the respective tooth surface describes a forming which has the consequence that the real bracket contacts the respective tooth at least essentially at an entire tooth surface. This means that a distance between a respective location of the tooth surface and a proximal location of the attachment surface of the bracket over an entire attachment surface of the bracket is not more than 0.5 mm, advantageously not more than 0.4 mm, further advantageously not more than 0.3 mm.

In a particularly advantageous method the bracket is cut from a piece of material, in particular cut out of a piece of sheet metal wherein a surface of the piece of sheet metal is oriented parallel to a side surface of the subsequent bracket. Put differently, the bracket can be advantageously cut from the piece of material so that a temporary cutting axis, e.g., of a laser or water beam, extends parallel to a width axis of the bracket or longitudinal axis of the bracket slot. When using this production method the finished bracket has a shape immediately after being cut from the piece of material wherein cross-sections of the shape orthogonal to the width axis of the bracket are identical. Put differently, the cross-section of the finished bracket is constant over the entire width of the bracket when using the described method.

### BRIEF DESCRIPTION OF THE DRAWINGS

The bracket according to the invention is subsequently described based on embodiments with reference to drawing figures, wherein:

FIG. 1: illustrates a cross-section through a first bracket according to the invention;

FIG. 2: illustrates a cross-section through a second bracket according to the invention;

FIG. 3: illustrates a cross-section through a third bracket according to the invention;

FIG. 4: illustrates a perspective view of a bracket according to the invention;

FIG. 5: illustrates a perspective view of another bracket according to the invention;

FIG. 6: illustrates a perspective view of another bracket according to the invention;

FIG. 7: illustrates a schematic cross-section of a tooth with a prior art bracket arranged thereon; and

FIG. 8: illustrates a cross-section according to FIG. 7, however, provided with the bracket according to the invention.

### DETAILED DESCRIPTION OF THE INVENTION

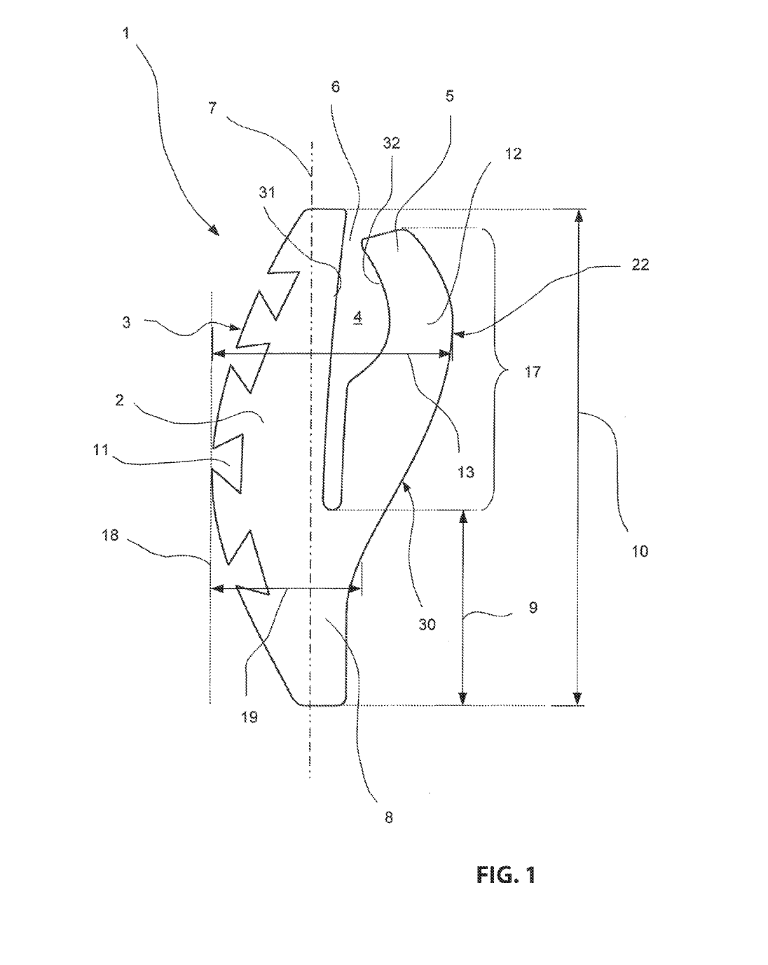

A first embodiment that is illustrated in FIG. 1 includes a bracket 1 according to the invention that includes a bracket base 2 and a locking device 5. The bracket base 2 and the locking device 5 are directly connected with each other by a bar 8. The bracket 1 includes an attachment surface 3 at a surface 28 of a tooth 27 that is not illustrated in FIG. 1 wherein the attachment surface is connected with the respective surface 28 in an inserted condition of the bracket 1 at least indirectly, advantageously directly.

In order to provide a better interconnection between the bracket 1 and the respective surface 28 of the respective tooth 27 the bracket base 2 includes a plurality of undercuts in a portion oriented towards the surface 28 wherein the undercuts are configured dovetailed in the illustrated embodiment. These undercuts respectively form a filling portion 11 that is configured to receive an attachment medium by which the bracket 1 is attached at the respective tooth 27. In particular, it is typical to attach brackets 1 with a synthetic material at a respective tooth 27. A synthetic material of this type is applied in a liquid condition to a respective surface 28 of the respective tooth 27 and connected with the respective bracket 1. Subsequently the synthetic material cures wherein the hardening either occurs self-acting over time or is initiated/accelerated by a special treatment, e.g., heat treatment. The fill-in portions 11 facilitate for the initially liquid synthetic material to enter into the fill-in portions 11 and then form a particularly durable interconnection between the respective surface 28 and the bracket 1 according to the invention during curing of the synthetic material.

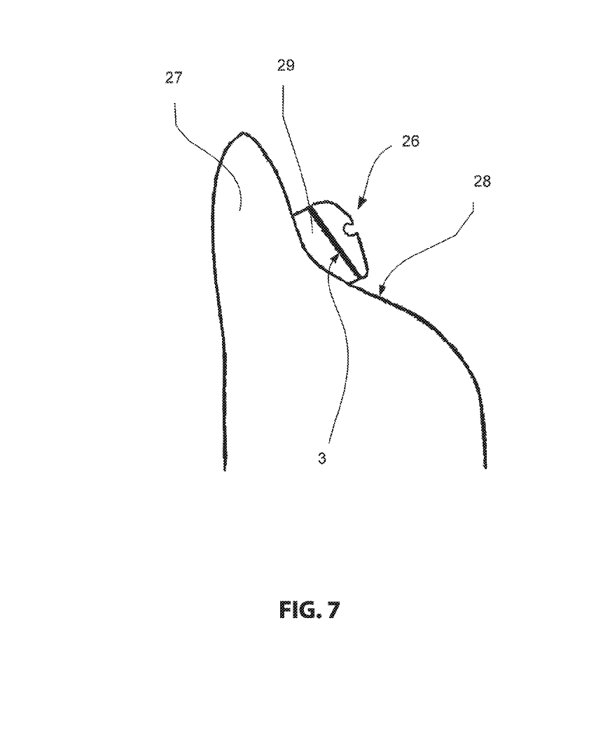

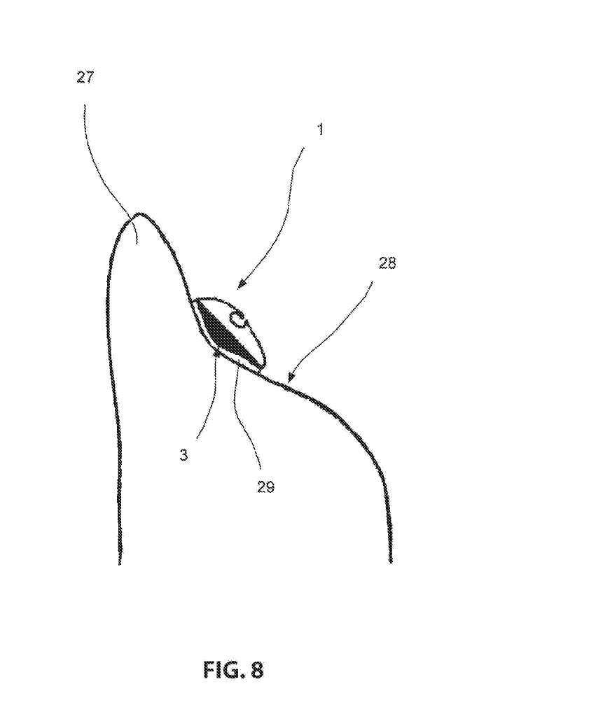

It is evident that the attachment surface 3 is configured cambered. An embodiment of this type can be individually adapted to a respective surface 28 of a tooth 27 so that a shorter distance of a respective spot of the attachment surface 3 from the corresponding surface 28 over an entire attachment surface 3 in the inserted condition of the bracket 1 is not more than 0.5 mm, advantageously not more than 0.4, further advantageously not more than 0.3 mm. The individual configuration of the attachment surface 3 as a function of the shape and contour of a respective tooth 27 can be performed in a particularly simple manner by the individual production method wherein the respective tooth 27 is individually detected, e.g., by an interoral scan, and the bracket 1 is designed and eventually fabricated as a function of the captured data. A comparison between the prior art standard bracket and the bracket 1 according to the invention is evident from FIGS. 7 and 8.

The bracket 1 includes a bracket slot 4 on a side of the bracket base 2 that is oriented away from the attachment surface 3. The bracket slot 4 is configured to receive an arch wire 20 that is not illustrated in FIG. 1 in a form-locking manner. This means that a respective arch wire 20 is insertable into the bracket slot 4 so that it is not easily movable out of the bracket slot 4. In particular, movements of the respective arch wire 20 are prevented which are oriented perpendicular to its longitudinal axis 24, that means they are in the drawing plane of FIG. 1. The fixation of the arch wire 20 within the bracket slot 4 is essentially caused by the locking device 5. The locking device is configured in a shape of a half pincer which extends from a lower portion of the bracket 1 essentially vertically upward parallel to the bracket base 2.

The bracket 1 according to the invention is integrally provided in one piece, Thus, the locking device 5 and the bracket base 2 are formed directly from the same piece and therefore only designate different portions of the same component. A transition portion between the locking device 5 and the bracket base 2 is designated as a bar 8. The material from which the illustrated bracket 1 is formed is a highly elastic material configured as a shape-memory material, namely a nickel-titanium alloy (Nitinol®). This material is among the so-called super-elastic materials that have an unusually pronounced elastic portion and are thus not plastically deformable. The one-piece configuration of the bracket 1 according to the invention made from a highly elastic material of this type facilitates inserting one or several arch wires 20 into the bracket slot 4 repeatedly and retrieving the arch wires again without damaging the material, e.g., by fatigue, In the illustrated embodiment an insertion opening 6 of the bracket slot 4 is arranged above the bracket slot 4. This has the consequence that a respective arch wire 20 is inserted into the bracket slot 4 so to speak in a direction parallel to a surface 28 of a tooth 27 that is oriented towards the bracket. Put differently, an assembly direction of the respective arch wire 20 is oriented at least approximately parallel to a vertical axis 7 of the bracket 1 for the bracket 1 according to the invention as illustrated in FIG. 1.

When inserting a respective arch wire 20 into the bracket slot 4 the bracket 1 is stretched in the portion of the insertion opening 6, this means that the locking device 5 is moved relative to the bracket base 2 in a direction that is oriented away from the surface 28 of the respective tooth 27 so that the insertion opening 6 expands. This expansion eventually reaches a dimension so that the arch wire 20 can move through the expanded insertion opening 6 into the bracket slot 4. Due to the configuration of the bracket 1 from the highly elastic material the expansion or the relative movement between the locking device 5 and the bracket base 2 occurs without any plastic deformation of the bracket 1. Put differently, the material of the bracket 1 only goes through elastic deformations which are completely reversible without any residual deformation remaining. During the movement of the locking device 5 in a direction away from the bracket base 2 the material of the bracket 1 in the portion of the bar 8 is elastically deformed and stretched. After inserting the respective arch wire 20 into the bracket slot 4 no additional force impacts the locking device 5 so that the material of the bracket 1 can spring back elastically so that the material is eventually provided again in its starting position that is illustrated in FIG. 1 in which the locking device 5 closes the bracket slot 4 and retains the arch wire 20 arranged therein.

In order to provide the locking device 5 with some flexibility, it is particularly advantageous when the bar 8 between the locking device 5 and the bracket base 2 is not configured too thick or too wide. In the illustrated embodiment the height 9 of the bar 8 is less than half of an entire height 10 of the bracket 1. It is appreciated that the bracket 1 overall and thus also the locking device 5 become much stiffer with the bar of the bracket 1 having a greater height 9. The greater stiffness of the bracket 1 would also have the effect that the locking device 5 is not moved in the same way relative to the bracket base 2 so that the insertion opening 6 could be expanded. Thus, it is particularly advantageous for he illustrated embodiment of the bracket 1 according to the invention.

According to the invention the bracket 1 has a camber 12 at a backside 30 that is oriented away from the attachment surface 3 wherein the camber extends in an associated portion 17 of the bracket 1. Thus, the camber 12 has only a secondary relevance for the function of the bracket 1 as an attachment element for transmitting forces between the respective tooth 27 and the respective arch wire 20. Primarily the camber 12 is used for moving the bracket 1 according to the invention after completion of a treatment step in which the respective teeth to be treated are moved by one or plural arch wires 20 and thus to reuse the bracket 1 during another treatment step using tooth rails. Tooth rails of this type are placed over the teeth to be treated wherein a respective tooth rail is sized so that it cannot be slid over the teeth to be treated precisely fitted. A pressure that forms between the tooth rails and the teeth and that occurs due to a lack of fit between both components has the consequence that the teeth are moved relative to each other. It is appreciated that these exact movements of the teeth which are advantageous for the treatment process can be caused when the tooth rail is configured accordingly.

In order to generate a better force transmission between a respective tooth and a tooth rail, typically so-called “attachments” are used. The attachments are applied to a respective tooth surface and are used, so to speak, as a contact element for the respective tooth rail. In order to achieve this result, the attachments are typically configured so that a contact surface that shall be in a direct contact with the respective tooth rail is at least arranged at a particular distance from a respective tooth surface of the tooth to be treated. Thus, it is appreciated that an attachment is less useful the smaller the distance between the actual tooth surface and the contact surface of the respective attachment. In an extreme case, no attachment is required at all but the tooth surface itself suffices as a contact surface for the respective tooth rail.

The camber 12 of the bracket 1 according to the invention is advantageous in that the bracket 1 according to the invention can be reused after completion of the arch wire treatment to form a transmission element or attachment. The camber 12 thus has the effect of providing a contact surface 22 as a stop for a respective tooth rail.

In order to function as an attachment while being reused the bracket 1 has a maximum thickness 13 in the portion 17 of the camber 12 wherein the maximum thickness has approximately 1.5 times the size of an average thickness 19 of the bracket 1 outside of the portion 17 of the camber 12. The respective thickness 13, 19 of the bracket 1 is thus measured in a direction perpendicular to the vertical axis 7, wherein a tangent 18 that is oriented parallel to the vertical axis 7 on a side of the bracket 1 that is oriented towards the tooth to be treated is used as a reference line. Furthermore, the camber 12 extends in the illustrated embodiment overall over a heights which corresponds to approximately 60% of the height 10 of the bracket 1. Furthermore, the illustrated bracket 1 has a distinct advantage in that its backside 30 is configured entirely without a recessed shoulder. This way a respective tooth rail has no ability to recede into the recessed portion which would make it much more difficult and potentially impossible to remove the tooth rail.

The bracket slot 4 of the bracket 1 according to the invention is formed in the illustrated embodiment at one of its side surfaces 31 by the bracket base 2 and at the opposite side surface 32 by the locking device 5.

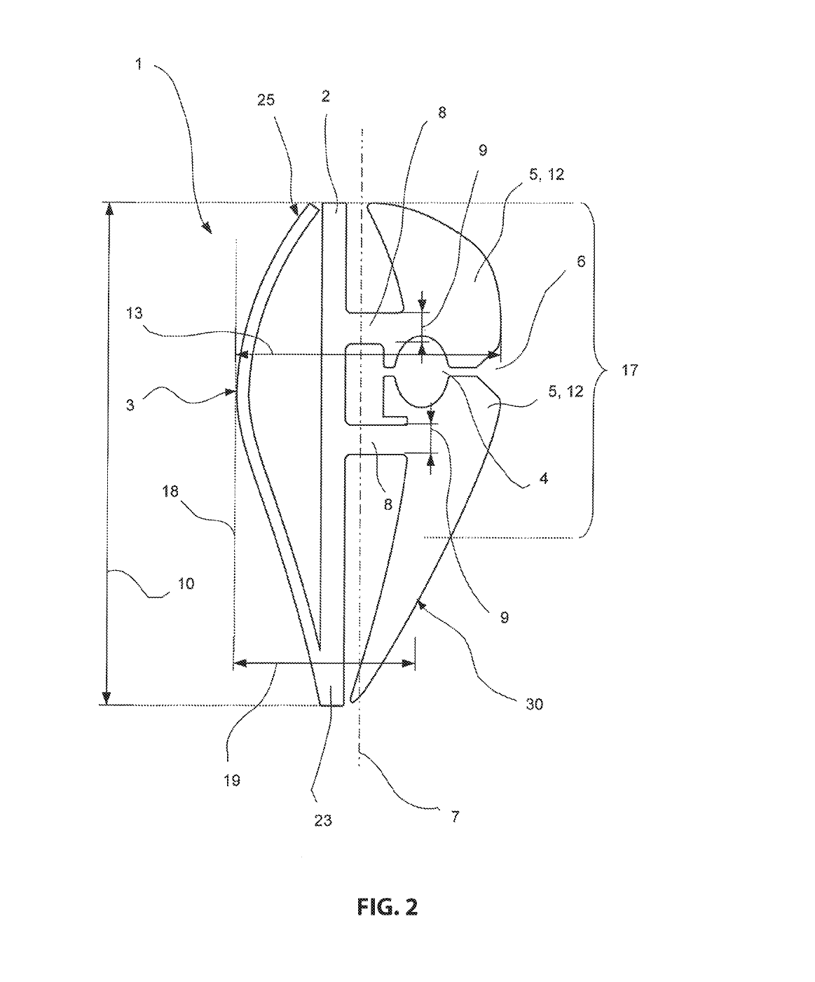

A second embodiment that is illustrated in FIG. 2 includes a bracket 1 according to the invention. The bracket 1 according to the second embodiment differs from the bracket 1 according to the first embodiment in particular in that an assembly direction of an arch wire that is to be inserted into the bracket slot 4 of the bracket 1 is not at least oriented essentially parallel to the vertical axis 7 of the bracket 1 like in the bracket 1 according to the first embodiment but essentially perpendicular thereto. Accordingly the insertion opening 6 of the bracket 1 is arranged at a backside 30 of the bracket 1 according to the second embodiment. This creates at least a risk that the backside 30 is not configured without recessed shoulder. This creates at least a risk that a respective tooth rail moves into the recessed shoulder that is formed by the insertion opening 6 which could render removing the tooth rail more difficult.

The second bracket 1 has two locking devices 5 that respectively define a side of the bracket slot 4. The locking devices 5 are respectively connected by a bar 8 with the bracket base 2. Differently from the bracket 1 according to the first embodiment the bracket slot 4 is not jointly defined by the locking device 5 and the bracket base 2 but defined by two locking devices 5. The bracket base 2 therefore does not come in direct contact with a respective arch wire that is inserted in the bracket slot 4 in the illustrated embodiment.

Furthermore, the function of the second bracket 1 according to the invention is comparable to the function of the bracket 1, in particular the bracket 1 according to the invention has a camber 12. The bars 8 of the locking device 5 have a height 9 which facilitates elastically moving the locking devices 5 relative to the bracket base 2, in particular moving them relative to each other so that a respective arch wire 20 is insertable into the bracket slot 4 by expanding the insertion opening 6. Due to the elasticity of the material it is easily possible to remove the respective arch wire 20 from the bracket slot again and to insert, e.g., another arch wire 20. Put differently, the bracket 1 can be reused at will.

In a manner that is comparable to the first bracket 1 according to the invention, the second bracket 1 according to the invention also has the camber 12 according to the invention that is configured at the locking devices 5. In a portion 17 of the camber 12 a maximum thickness 13 of the bracket 1 is approximately 1.5 times the size as a thickness 19 outside of the portion 17 of the recess 12. The camber 12 is also facilitates to be able to use bracket 1 according to the invention in a treatment step using a tooth rail functioning as a transmission element or attachment,

On a side of the bracket 1 that is oriented away from the bracket slot 4 the bracket base includes an attachment section 25 at which the attachment surface 3 of the bracket 1 is configured. The attachment section 25 is in turn connected by a bar 23 with the remaining bracket base 2 so that a certain amount of elastic deformation is possible between the attachment section 25 and the remaining bracket base 2. This is advantageous in that the attachment section 25 including its attachment surface 3 can be formed particularly well according to a natural contour of the tooth that is to be treated.

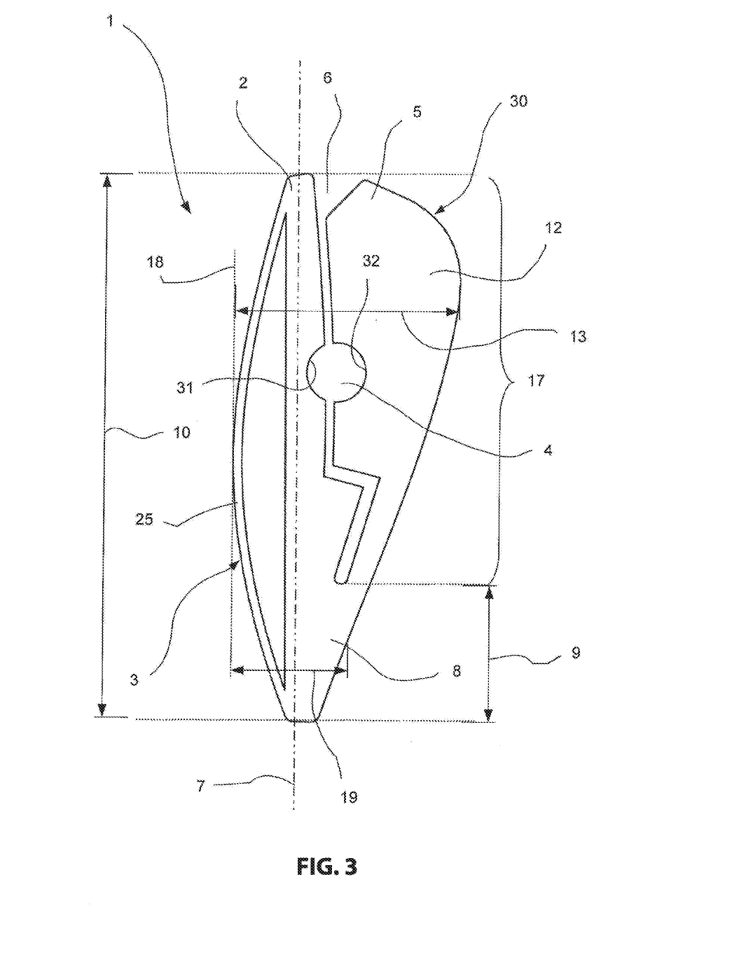

A third embodiment that is shown in FIG. 3 illustrates another bracket 1 according to the invention. In this bracket the associated bracket slot 4 is defined on one side by the locking device 5 which is comparable to the first embodiment and defined on the other side by the bracket base 2. The functionality of the illustrated bracket 1 is comparable to the functionality of the two previously recited embodiments wherein an arch wire 20 is inserted into the bracket slot 4 in a vertical direction that is parallel to the vertical axis 7 of the bracket 1 according to the first embodiment. The third embodiment shows in particular that the individual design of a respective bracket according to the invention can be quite different without losing the technical advantages of the claimed material combination. The camber 12 according to the invention extends over approximately 50% of a height 10 of the bracket 1.

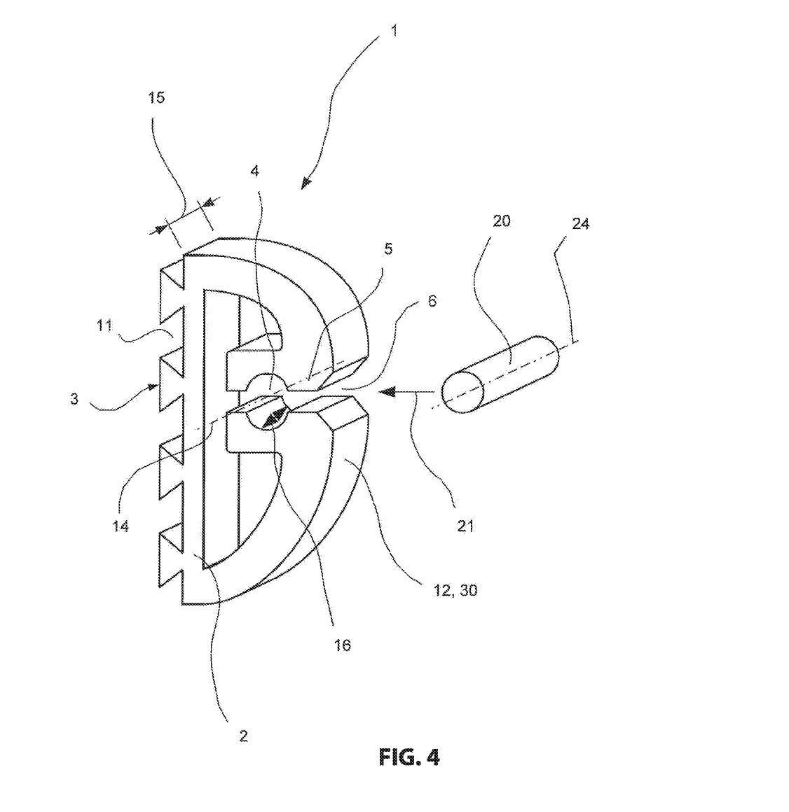

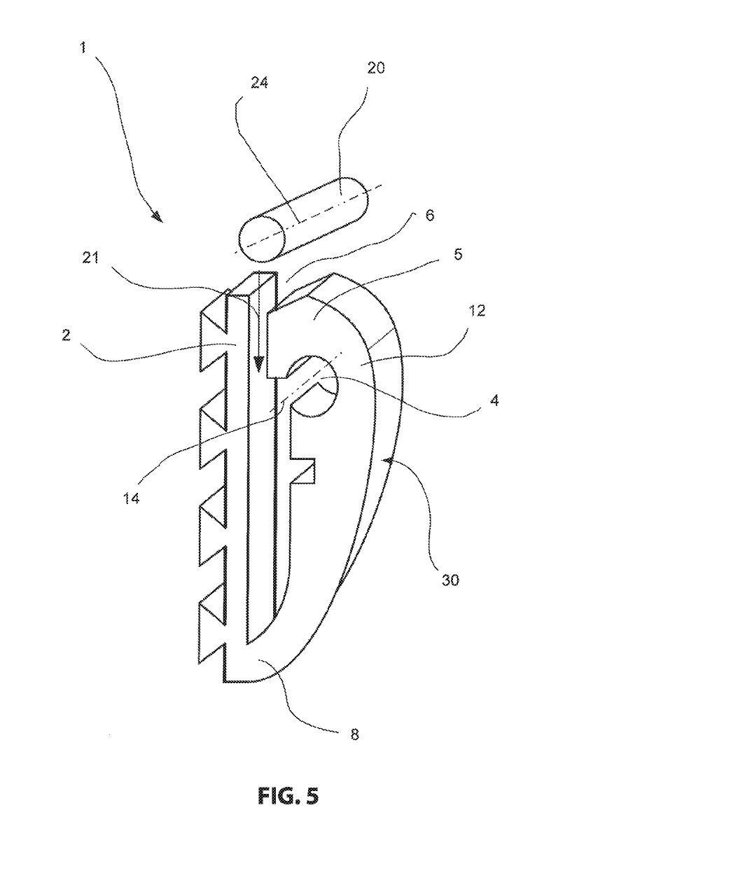

Perspective views of brackets 1 according to the invention can be furthermore derived from FIGS. 4-6. From these views it is evident in particular that the individual brackets 1 respectively have a width 15 that extends in a direction parallel to a longitudinal axis 24 of a respective arch wire. The width 15 of a respective bracket 1 typically correlates directly with a support length 16 along which a respective arch wire 20 is supported in the bracket slot 4 of the respective bracket 1. In the illustrated embodiments the width 15 of the illustrated bracket 1 and the support length 16 of the respective arch wire 20 are sized identical, The embodiments according to FIGS. 4 6 illustrate various options for a respective assembly direction of a bracket 20 that is illustrated by an arrow 21 in the drawing figures. Furthermore it is evident that the bracket 1 is as a matter of principle independent from a geometry or cross sectional shape of a respective arch wire.

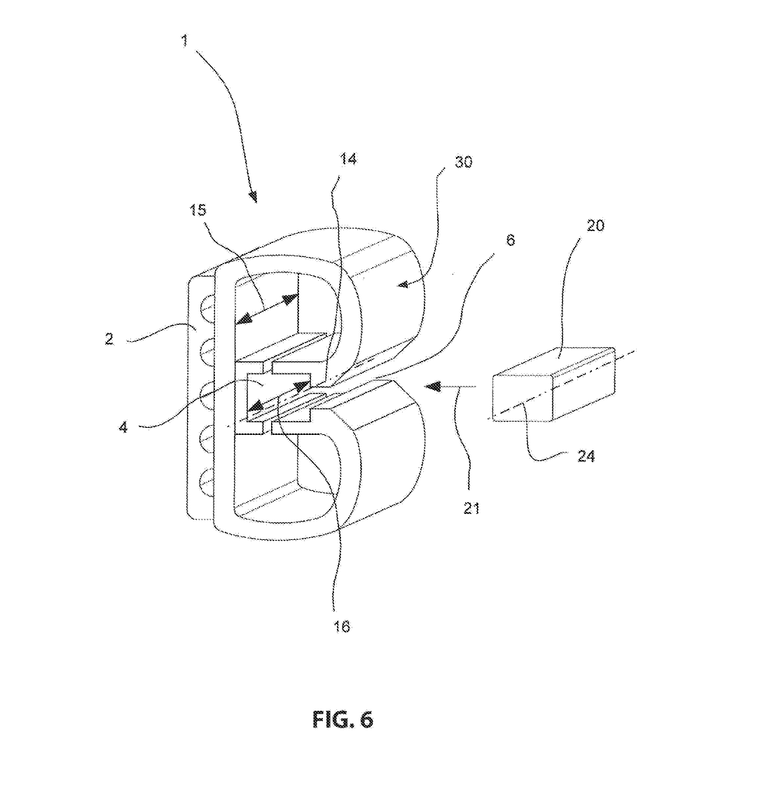

The bracket 1 according to the invention according to FIG. 6 is particular since it has an unusually large width 15. This width is approximately 2.5 mm. Accordingly also the support length 16 of the associated bracket 1 is 2.5 mm. A support length 16 with that size is particularly well suited to reliably support a respective arch wire 20 and to establish good force transmission between the arch wire 20 and the respective bracket 1 in this manner.

It is appreciated that a width 15 of a bracket according to the invention is as a matter of principle independent from other features of a respective bracket 1. This also applies as a matter of principle for the remaining features of the brackets 1 according to the invention illustrated herein.

Last not least two brackets 1 are compared in FIGS. 7 and 8 wherein FIG, 7 illustrates a known bracket 26 according to the prior art and FIG. 8 illustrates a bracket 1 according to the invention. The illustrations, however, are purely schematic and only serve to emphasize the advantage of the individual configuration options of the attachment surface 3 of a bracket 1. In the prior art a bracket 26 has to be adapted by a comparatively thick attachment layer 29 to an associated tooth 27 or its surface. The attachment surface 3 of the known bracket 26 is configured according to the standard and straight in the illustrated embodiment. In order to achieve an adaptation to the surface 28 of the tooth 27 the attachment surface 3 is shaped according to the surface 28 of the tooth 27 by an attachment surface 29. As a result the bracket 26 is rather far away from the tooth 27 and therefore exposed to rather large forces, in particular chewing forces. This often causes a bracket 26 to the torn off from a surface 28 of the tooth 27.

In a bracket 1 according to the invention that is schematically illustrated in FIG. 8 the attachment surface 3, however, can be individually adapted to the surface 28 of the tooth 27. As a result the bracket 1 according to the invention is very close to the surface 28 since the attachment layer 29 is configured very thin. Thus, the bracket 1 according to the invention protrudes into the oral cavity by a much lesser amount and is more comfortable during chewing. Furthermore the bracket 1 feels much more comfortable than a prior art bracket since it feels less like a foreign object.

Individual features of the embodiments illustrated herein can be practiced independently from the other features of the respective embodiment. A mandatory concatenation of individual features therefore only exist when a bracket 1 according to the invention is otherwise not practicable.

### REFERENCE NUMERALS AND DESIGNATIONS

1 bracket

2 bracket base

3 attachment surface

4 bracket slot

5 locking device

6 insertion opening

7 vertical axis

8 bar

9 height of bar

10 height of bracket

11 fill in portion

12 camber

18 maximum thickness of bracket

14 longitudinal axis of bracket slot

15 width of bracket

16 support length

17 portion of camber

18 tangent

19 mean thickness of bracket

20 arch wire

21 arrow

22 contact surface

23 bar

24 longitudinal axis of arch wire

25 attachment section

26 prior art bracket

27 tooth

28 tooth surface

29 attachment layer

30 backside of bracket

31 first side surface of bracket slot

32 second side surface of bracket slot.

What is claimed is:

1. A bracket, for an orthodontic device, the bracket comprising:
a bracket base including an attachment surface configured to attach the bracket at an associated surface of a tooth;
at least one bracket slot configured to receive at least one arch wire of the orthodontic device, wherein the at least one bracket slot is arranged on a side of the bracket base that is oriented away from the attachment surface; and
at least one locking device that is configured to lock at least the at least one bracket slot at least partially so that the arch wire is prevented from moving out of the at least one bracket slot,
wherein the bracket is integrally formed in one piece,
wherein the bracket is configured with a convex camber at a back side that is oriented away from the attachment surface, wherein the convex camber extends over at least 50% of a height of the bracket that is measured parallel to a vertical axis of the bracket.

2. The bracket according to claim 1, wherein the convex camber is configured without a recessed shoulder and without an undercut.

3. The bracket according to claim 1, wherein the convex camber extends over at least 60% or at least 70% or at least 80% of the height of the bracket.

4. The bracket according to claim 1,
wherein a maximum thickness of the bracket measured perpendicular to the vertical axis of the bracket is increased in a portion of the camber compared to a mean thickness of the bracket outside of the portion of the convex camber,
wherein the maximum thickness in the portion of the convex camber is at least 1.5 times or at least 2 times the amount of a mean thickness outside of the portion of the convex camber.

5. The bracket according to claim 1,
wherein an insertion opening of the bracket through which an arch wire is insertable into the at least one bracket slot is arranged at the bracket so that inserting the arch wire into the bracket slot is facilitated in a direction that is at least essentially parallel to the vertical axis of the at least one bracket so that in particular the back side of the bracket is free from insertion openings.

6. The bracket according to claim 5, wherein the bracket is made at least partially from Nitinol or from a thermoplastic synthetic material, or a polyetherketone, or polyetheretherketone, or a thermoplastic Fluor synthetic material, or polyvinylidenfluoride, or polyoxymethylene, or from a polymide, or polyetherimide

7. The bracket according to claim 5, wherein at least a first side surface of the at least one bracket slot is formed by the bracket base and a second side surface that is arranged opposite to the first side surface is formed by at least one interlocking element.

8. The bracket according to claim 1, wherein a cross section of the bracket is constant over an entire width of the bracket that is measured parallel to a longitudinal axis of the at least one bracket slot so that all cross sections through the bracket that extend orthogonal to the longitudinal axis of the at least one bracket slot are identical.

9. The bracket according to claim 1, wherein a width of the bracket that is measured parallel to a longitudinal axis of the bracket slot is at least 1.5 mm, or at least 2 mm, or at least 2.5 mm at least in the portion of the at least one bracket slot.

10. The bracket according to claim 1, wherein a support length of the bracket slot along which an arch wire is continuously supportable in the bracket slot is at least 1.5 mm, or at least 2.0 mm, or at least 2.5 mm.

11. An orthodontic device, comprising
at least one arch wire;
a plurality of brackets configured to receive the arch wire,
wherein the brackets are respectively configured to be connected with a surface of a tooth in a force transferring manner,
wherein the arch wire is receivable by the brackets so that a force transmitting connection is establishable between the arch wire and the teeth that cooperate with the brackets,
wherein the brackets respectively include at least one bracket slot configured to receive the arch wire and the arch wire is fixable in the at least one bracket slot by a locking device so that a movement of the arch wire relative to the bracket slot is blocked at least in a direction perpendicular to a longitudinal axis of the arch wire,
wherein the bracket slot cooperates with an insertion opening of the bracket, wherein the arch wire (20) is insertable into the bracket slot (4) through the insertion opening,
wherein the brackets are respectively integrally configured in one piece, and
wherein at least one of the brackets is configured with a convex camber at a back side that is oriented away from the attachment surface,
wherein the convex camber extends without a recessed shoulder over at least 50% of an entire height of the bracket that is measured parallel to a vertical axis of the bracket.

12. A method for producing a bracket according to claim 1 for an orthodontic device, the method comprising the steps:
virtually designing the bracket by a CAD method to generate a virtually designed bracket;
producing the virtually designed bracket by a CAM-method wherein the virtually designed bracket is cut from a piece of material so that the bracket is provided integrally in one piece after completion of the cutting and has its final shape that is functional in the orthodontic device.

13. A method for producing a bracket for an orthodontic device, the method comprising the steps:
virtually designing a bracket by a CAD method to generate a virtually designed bracket;
master forming the virtually designed bracket by a 3-D printing method so that the virtually designed bracket is integrally provided in one piece after completing of the 3-D method and so that the bracket has its final shape that is functional in the orthodontic device.

14. The method according to claim 12, wherein a locking device by which at least one bracket slot of the bracket is lockable so that the arch wire is prevented from moving out of the bracket slot is directly integrally configured in one piece at the bracket.

15. The method according to claim 12, further comprising the steps:
detecting the teeth to be treated by a scanning device and subsequently generating a digital model of the teeth using scanned data;
designing at least one virtual bracket in the digital model wherein the at least one virtual bracket is adapted to a respective tooth of the digital model so that an attachment surface of the virtual bracket is at least essentially shaped according to a corresponding surface of the respective tooth, so that the attachment surface is applicable at least essentially with its entire surface to the surface of the respective tooth;
cutting a corresponding real bracket from a piece of material or master forming it by a 3-D printing method based on the virtual bracket so that the real bracket is integrally provided in one piece after the cutting or master forming and is immediately provided in its final shape that is usable in an orthodontic device.

16. The method according to claims 12, wherein the bracket is cut from a piece of nitinol sheet material by a laser or water jet.
